(19) United States
(12) Patent Application Publication
(10) Pub. No.: US 2008/0213671 A1
(43) Pub. Date: Sep. 4, 2008

(54) NEGATIVE ELECTRODE FOR LITHIUM ION SECONDARY BATTERY AND LITHIUM ION SECONDARY BATTERY

(76) Inventors: Yasutaka Kogetsu, Osaka (JP); Kazuya Iwamoto, Osaka (JP); Taisuke Yamamoto, Osaka (JP)

Correspondence Address: MCDERMOTT WILL & EMERY LLP, 600 13TH STREET, NW, WASHINGTON, DC, 20005-3096, US

(21) Appl. No.: 12/036,767

(22) Filed: Feb. 25, 2008

(30) Foreign Application Priority Data
Mar. 2, 2007 (JP) 2007-052337

(51) Int. Cl. H01M 4/24; H01M 2/14

(52) U.S. Cl. 429/246

(57) ABSTRACT

A negative electrode including a negative electrode current collector, first protrusions on a surface of the negative electrode current collector, a separation-stopping area on at least a part of a surface of each first protrusion, and a negative electrode active material layer including a negative electrode active material and formed on at least a top face of the first protrusion. This structure suppresses the separation of the negative electrode active material layer from the negative electrode current collector, the degradation of the current collecting ability, and the deformation of the negative electrode itself. A lithium ion secondary battery including this negative electrode has a high battery capacity, a high energy density, and an excellent charge/discharge cycle characteristic, and is capable of stably maintaining a high power over an extended period of time.

### FIELD OF THE INVENTION

The invention relates to a negative electrode for a lithium ion secondary battery and a lithium ion secondary battery. More particularly, the invention mainly relates to improvements in the negative electrode for a lithium ion secondary battery.

### BACKGROUND OF THE INVENTION

With the recent, remarkable widespread use of portable electronic devices, such as personal computers, cellular phones, and mobile devices, there is an increasing demand for batteries used as the power source for portable electronic devices. The batteries for use in portable electronic devices are required to operate at room temperature, have a large battery capacity, and offer a high energy density and an excellent charge/discharge cycle characteristic. One such battery is a lithium ion secondary battery which includes a positive electrode including a positive electrode active material capable of reversibly absorbing and desorbing lithium ions, a negative electrode including a negative electrode active material capable of absorbing and desorbing lithium ions, and a lithium-ion conductive electrolyte. Although the lithium ion secondary battery is currently sufficient in battery capacity, energy density and charge/discharge cycle characteristic and widely used as the power source for portable electronic devices, it is required to have a higher capacity in order to provide portable electronic devices with higher functions.

To heighten the capacity of the lithium ion secondary battery, it has been proposed to use, for example, silicon (Si), tin (Sn), an oxide thereof, or an alloy thereof as a negative electrode active material. Since these materials have very high capacities, the use of such materials can provide high capacity batteries. However, when such a material absorbs and desorbs lithium, it expands and contracts due to a change in crystal structure. Thus, when such a material is contained in a negative electrode active material layer formed on the surface of a negative electrode current collector, the negative electrode active material layer expands and contracts upon charge/discharge. The resulting stress at the interface between the negative electrode current collector and the negative electrode active material layer decreases the adhesion of the negative electrode active material layer to the negative electrode current collector, so that the negative electrode active material layer becomes partially separated from the negative electrode current collector. This partial separation eventually leads to separation of other parts. As more parts of the negative electrode active material layer become separated from the negative electrode current collector, it becomes more difficult to collect current therefrom, so that the charge/discharge cycle life becomes shorter.

To address such problem, for example, Japanese Patent No. 3733065 (hereinafter referred to as “Patent Document 1”) proposes a negative electrode for a lithium battery including a negative electrode current collector with a roughened surface and an amorphous silicon thin film (negative electrode active material layer) formed on the roughened surface of the negative electrode current collector. The largest feature of the technique of Patent Document 1 is the use of the amorphous silicon thin film as the negative electrode active material layer. The amorphous silicon thin film is characterized in that when it expands and contracts upon charge/discharge, slits (spaces) are regularly formed in the thickness direction thereof. As a result of the formation of the slits, the amorphous silicon thin film is divided into independent columnar structures, thereby becoming an assembly of the columnar structures. Patent Document 1 states that since the stress created by the expansion and contraction of these columnar structures is eased by the slits (spaces), the separation of the columnar structures is prevented.

It should be noted, however, that a relatively strong stress is created upon the formation of the slits. Such stress often causes the ends of the columnar structures adjacent to the slits to separate from the negative electrode current collector. Even if the expansion/contraction stress is eased by the slits, once the ends of the columnar structures start to separate, other parts thereof also gradually start to separate. Also, even if the ends of the columnar structures do not become separated, the expansion/contraction stress upon charge/discharge concentrates on the interface between the central parts of the columnar structures and the negative electrode current collector. It is thus impossible to avoid partial separation of the columnar structures from the negative electrode current collector, deformation of the negative electrode current collector, etc. Therefore, the technique of Patent Document 1 cannot prevent the separation of the negative electrode active material layer in a sufficient and reliable manner. Further, according to the technique of Patent Document 1, the negative electrode active material is limited to only materials that will cause slits due to charge/discharge, and therefore, only limited negative electrode active materials can be used. Furthermore, Patent Document 1 is silent about any technique to stop a partially separated negative electrode active material layer from becoming more separated from the negative electrode current collector.

### BRIEF SUMMARY OF THE INVENTION

It is therefore an object of the invention to provide a negative electrode for a lithium ion secondary battery in which the separation of the negative electrode active material layer and the deformation of the negative electrode itself are significantly reduced so that the current collecting ability can be maintained at a high level.

It is another object of the invention to provide a lithium ion secondary battery including the negative electrode of the invention which has a high battery capacity, a high energy density, and an excellent charge/discharge cycle characteristic and is capable of stably maintaining a high power over an extended period of time.

The invention provides a negative electrode for a lithium ion secondary battery, comprising: a negative electrode current collector made of metal and shaped like a plate; first protrusions on a surface of said negative electrode current collector; a columnar structure formed on at least a top face of each of said first protrusions, said columnar structure including a negative electrode active material; and a separation-stopping area provided on at least a part of a surface of each of said first protrusions for stopping said columnar structure from becoming separated from the surface of said first protrusion due to expansion or contraction of said negative electrode active material.

Preferably, the separation-stopping area is provided on at least a part of the side face of each of the first protrusions.

In one embodiment, the separation-stopping area preferably includes one or more steps formed on the side face of each of the first protrusions.

At least one of the one or more steps is preferably shaped like stairs.

In another embodiment, the separation-stopping area preferably includes one or both of: 1) a depression in the side face; and 2) a second protrusion on the side face, in the circumferential direction of the side face of the first protrusion.

The depression is preferably formed in the side face of the first protrusion in the neighborhood of the surface of the negative electrode current collector.

The invention also provides a lithium ion secondary battery including: a positive electrode including a positive electrode active material capable of reversibly absorbing and desorbing lithium ions; any one of the negative electrodes described above; a separator; and a lithium-ion conductive electrolyte.

In the negative electrode of the invention, even when the negative electrode active material expands and contracts upon charge/discharge, the negative electrode active material layer hardly becomes separated from the negative electrode current collector. Also, even if the negative electrode active material layer becomes partially separated, other parts of the negative electrode active material layer do not become separated. Therefore, in the negative electrode of the invention, the separation of the negative electrode active material layer and the deformation of the negative electrode itself are significantly reduced, so that the current-collecting ability is high over an extended period of time.

Also, even when the lithium ion secondary battery including the negative electrode of the invention is repeatedly charged/discharged, the separation of the negative electrode active material layer and the deformation of the negative electrode itself are significantly reduced, so that the ability of the negative electrode to collect current is maintained at a high level. That is, it is possible to use high-capacity negative electrode active materials that expand and contract upon charge/discharge. Therefore, the lithium ion secondary battery of the invention has a high battery capacity, a high energy density, an excellent charge/discharge cycle characteristic, and a long service life, and is capable of stably maintaining a high power over an extended period of time.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of the structure of a lithium ion secondary battery in a first embodiment of the invention;

FIG. 2 is an enlarged schematic longitudinal sectional view of the structure of the area of the negative electrode surrounded by the chain double-dashed line II-II in FIG. 1;

FIG. 3 is an enlarged schematic longitudinal sectional view of the structure of the main part of the negative electrode illustrated in FIG. 2;

FIG. 4 shows schematic longitudinal sectional views of the structures of the main parts of negative electrode current collectors in different modes;

FIG. 5 is a longitudinal sectional view of a negative electrode active material layer in one mode; and

FIG. 6 is a schematic longitudinal sectional view of the structure of an electron beam deposition device.

### BRIEF DESCRIPTION OF THE INVENTION

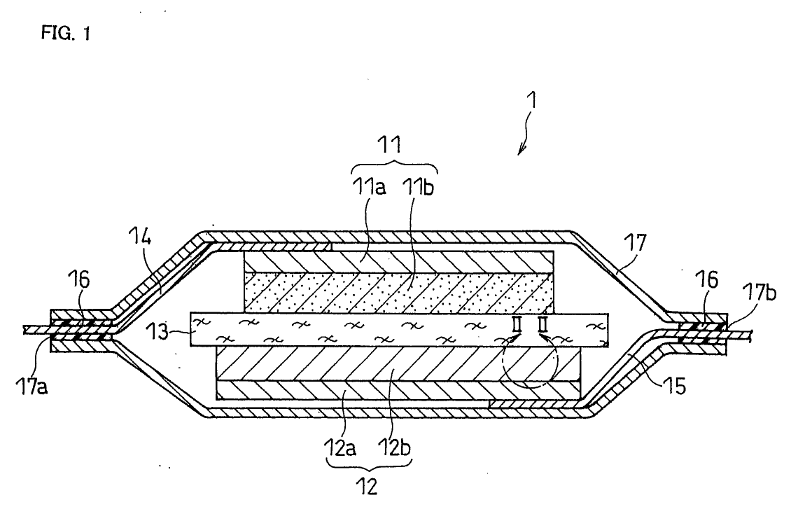

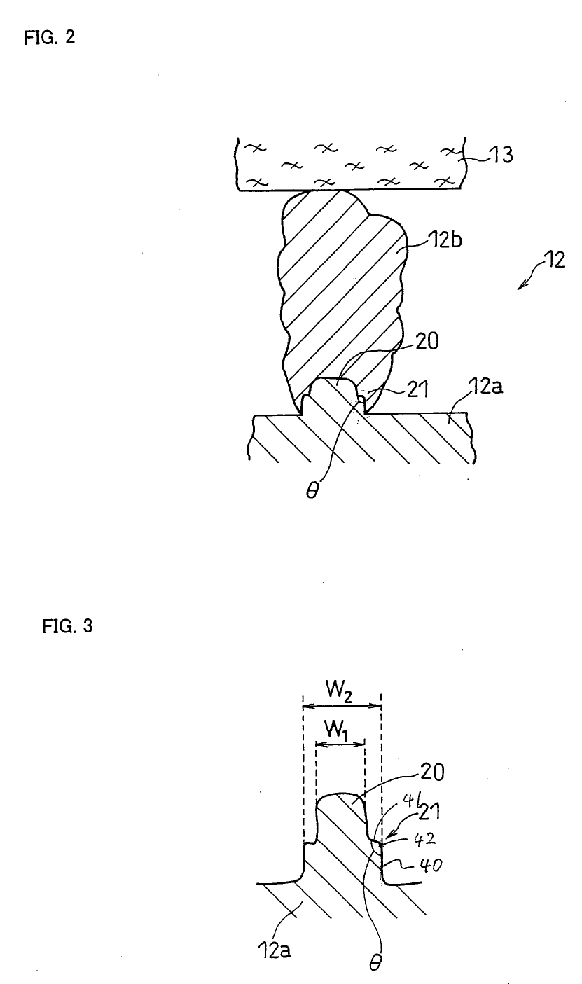

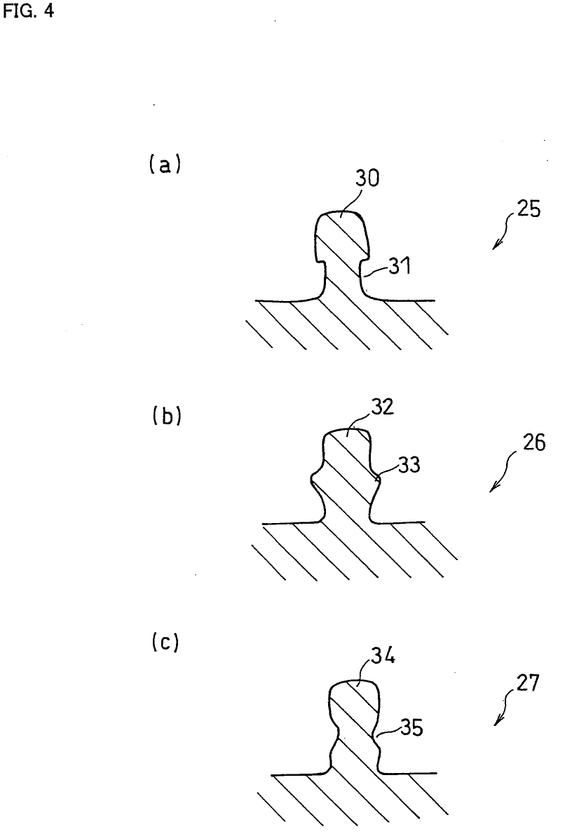

FIG. 1 is a schematic longitudinal sectional view of the structure of a lithium ion secondary battery 1 in a first embodiment of the invention. FIG. 2 is an enlarged schematic longitudinal sectional view of the structure of the area of a negative electrode 12 surrounded by the chain double-dashed line II-II in FIG. 1. FIG. 3 is an enlarged schematic longitudinal sectional view of the structure of the main part of the negative electrode 12 illustrated in FIG. 2. The lithium ion secondary battery 1 includes a positive electrode 11, the negative electrode 12, a separator 13, a positive electrode lead 14, a negative electrode lead 15, a gasket 16, and an exterior case 17.

The positive electrode 11 includes a positive electrode current collector 11a and a positive electrode active material layer 11b.

The positive electrode current collector 11a can be any material commonly used in this field, and examples include porous or non-porous conductive substrates. Examples of materials for conductive substrates include metal materials such as stainless steel, titanium, aluminum, and nickel, and conductive resin. The shape of the positive electrode current collector 11a is not particularly limited, and for example, the positive electrode current collector is preferably shaped like a plate such as a sheet or a film. When the positive electrode current collector 11a is in the form of a plate, the thickness thereof is not particularly limited, and it is preferably 1 to 50 μm, and more preferably 5 to 20 μm.

The positive electrode active material layer 11b may be provided on one face of the positive electrode current collector 11a as illustrated in FIG. 1, or may be provided on both faces of the positive electrode current collector 11a. The positive electrode active material layer 11b includes a positive electrode active material and may contain a conductive agent, a binder, etc., if necessary.

The positive electrode active material can be any material commonly used in this field, and examples include lithium-containing composite metal oxides, chalcogenides, and manganese dioxide. A lithium-containing composite metal oxide is a metal oxide containing lithium and one or more transition metals, or such a metal oxide in which a part of the transition metal(s) is replaced with one or more different elements. Examples of different elements include Na, Mg, Sc, Y, Mn, Fe, Co, Ni, Cu, Zn, Al, Cr, Pb, Sb, and B, and, for example, Mn, Al, Co, Ni, and Mg are preferred. Among them, lithium-containing composite metal oxides are preferably used. Specific examples of lithium-containing composite metal oxides include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂ MPO₄F, where M represents at least one element selected from the group consisting of Na, Mg, Sc, Y, Mn, Fe, Co, Ni, Cu, Zn, Al, Cr, Pb, Sb, V, and B, x=0 to 1.2, y=0 to 0.9, and z=2.0 to 2.3. The value x representing the molar ratio of lithium increases/decreases due to charge/discharge. Examples of chalcogenides include titanium disulfide and molybdenum disulfide. These positive electrode active materials can be used singly or in combination of two or more of them.

The conductive agent can be any material commonly used in this field, and examples include graphites such as natural graphite and artificial graphite, carbon blacks such as acetylene black, ketjen black, channel black, furnace black, lamp black, and thermal black, conductive fibers such as carbon fiber and metal fiber, carbon fluoride, metal powders such as aluminum, conductive whiskers such as zinc oxide, conductive metal oxides such as titanium oxide, and organic conductive materials such as phenylene derivatives. These conductive agents can be used singly or, if necessary, in combination of two or more of them.

The binder can also be any material commonly used in this field, and examples include polyvinylidene fluoride (PVDF), polytetrafluoroethylene (PTFE), polyethylene, polypropylene, aramid resin, polyamide, polyimide, polyamide-imide, polyacrylnitrile, polyacrylic acid, polymethyl acrylates, polyethyl acrylates, polyhexyl acrylates, polymethacrylic acid, polymethyl methacrylates, polyethyl methacrylates, polyhexyl methacrylates, polyvinyl acetates, polyvinyl pyrrolidone, polyether, polyethersulfone, polyhexafluoropropylene, styrene-butadiene rubber, ethylene-propylenediene copolymer, and carboxymethyl cellulose. It is also possible to use a copolymer of two or more monomer compounds selected from, for example, tetrafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. These binders can be used singly or, if necessary, in combination of two or more of them.

The positive electrode 11 can be produced, for example, by applying a positive electrode mixture slurry containing a positive electrode active material onto one face or both faces of the positive electrode current collector 11a and drying it to form the positive electrode active material layer 11b. The positive electrode mixture slurry contains a positive electrode active material and optionally a conductive agent, a binder, etc., and can be prepared by dissolving or dispersing these solid components in a suitable organic solvent. The organic solvent can be any material commonly used in this field, and examples include dimethylformamide, dimethyl acetamide, methyl formamide, N-methyl-2-pyrrolidone (NMP), dimethyl amine, acetone, and cyclohexanone. These organic solvents can be used singly or in combination of two or more of them. When a positive electrode active material, a conductive agent, and a binder are used together, their amounts can be selected as appropriate. The amount of the positive electrode active material is preferably 80 to 97% by weight of the total amount (hereinafter “the solid contents”) of the positive electrode active material, the conductive agent, and the binder. The amount of the conductive agent is preferably 1 to 20% by weight of the solid contents, and the amount of the binder is preferably 1 to 10% by weight of the solid contents. Within these ranges, the amounts of these three components can be freely selected such that the total amount thereof is 100% by weight.

The negative electrode 12 includes a negative electrode current collector 12a and a negative electrode active material layer 12b composed of columnar structures. The negative electrode active material layer 12b is disposed so as to face the positive electrode active material layer 11b of the positive electrode 11 with the separator 13 interposed therebetween. As illustrated in FIG. 2 and FIG. 3, the negative electrode current collector 12a has a first protrusion 20 and a separation-stopping area 21 on the surface. FIG. 2 and FIG. 3 are cross-sectional views in the extending direction of the first protrusion 20.

The first protrusion 20 is formed so as to extend outwardly from the surface of the negative electrode current collector 12a. Also, the first protrusion 20 may be formed so that the top face thereof includes a plane that is substantially parallel to the surface of the negative electrode current collector 12a. As used herein, the top face refers to the portion of the first protrusion 20 furthest from the surface of the negative electrode current collector 12a. Also, a plurality of first protrusions 20 are provided on the surface of the negative electrode current collector 12a. The number of the first protrusions 20, the interval between the first protrusions 20, etc. are not particularly limited, and can be freely selected depending on the size of the first protrusions 20 (height from the surface of the negative electrode current collector 12a to the top face, cross-sectional diameter, etc.), the size of the negative electrode active material layer 12b formed on the surface of the first protrusion 20, etc. The size of the first protrusions 20 is not particularly limited, and for example, the cross-sectional diameter is approximately 1 to 50 μm and the height is approximately 1 to 10 μm. The number of the first protrusions 20 is also not particularly limited, and for example, it is approximately 10,000 to 10,000,000/cm². Also, when the first protrusions 20 are cylindrical, the axis-to-axis distance of adjacent first protrusions 20 is preferably in the range of 2 to 100 μm. The size of the first protrusions 20 can be obtained, for example, by observing a cross-section of the negative electrode current collector 12a with the first protrusions 20 in the extending direction of the first protrusions 20 with a scanning electron microscope, measuring the cross-sectional diameters and heights of 5 to 10 first protrusions 20, and averaging the obtained values thereof.

It should be noted that upon the initial charge, during which the expansion stress of the negative electrode active material reaches maximum, each of the first protrusions 20 may undergo plastic deformation, but that after the initial charge, the first protrusion 20 does not deform due to the expansion and contraction of the negative electrode active material. This is probably because during the initial charge, a diffusion path of lithium is formed, the elemental alignment of the negative electrode active material is optimized, and the expansion/contraction stress is reduced. The whole negative electrode active material layer 12b does not become separated from the first protrusion 20 due to the plastic deformation of the first protrusion 20 upon the initial charge. Therefore, the first protrusion 20 can hold the negative electrode active material layer 12b over an extended period of time.

The separation-stopping area 21 is provided on a side face of the first protrusion 20 in the extending direction of the first protrusion 20 (hereinafter simply “side face”). In this way, when the separation-stopping area 21 is provided on at least a part of the side face of the first protrusion 20, the separation of the negative electrode active material layer 12b can be stopped more effectively. Also, since the separation-stopping area 21 can be formed easily, it is possible to produce the separation-stopping area 21 in an efficient and industrially advantageous manner.

Specifically, the separation-stopping area 21 is provided as a step that extends outwardly from the side face of the first protrusion 20. In a cross-section of the first protrusion 20 in the extending direction of the first protrusion 20, the angle θ of the protruding portion of the step is preferably about 30° to 150°, and more preferably about 90°. Further, the surface of this step preferably includes a surface with a radius of curvature, i.e., a curved surface. In this embodiment, the separation-stopping area 21 is a step with an angle θ of approximately 90°. Also, FIG. 2 illustrates a single step, but this is not to be construed as limiting, and if possible, two or more steps such as those of stairs may be provided. The angle θ is measured, for example, as follows. A photo of a cross-section of the negative electrode current collector 12a with the first protrusion 20 in the extending direction of the first protrusion 20 is taken through a scanning electron microscope. In the electron micrograph, the vertex of the protruding portion of the separation-stopping area 21 is determined. While the vertex can be any point that is highest in the protruding portion, it is usually a point of intersection of the line 40 extending from the surface of the negative electrode current collector 12a and the line 41 extending from the side face of the first protrusion 20 in a cross-section of the separation-stopping area 21. From the vertex 42, a shortest straight line to the surface of the negative electrode current collector 12a and a shortest straight line to the side face of the first protrusion 20 are drawn, and the angle formed by these two straight lines is measured. This measurement is performed on 5 to 10 samples, and the average value is used as the angle θ.

Also, in FIG. 3, the ratio of the cross-sectional diameter W₁ of the top face of the first protrusion 20 to the cross-sectional diameter W₂ of the portion of the first protrusion 20 having the separation-stopping area 21 is not particularly limited, but W₁ is preferably 5 to 40% of W₂.

As described above, when the separation-stopping area 21 is provided as the step on the side face of the first protrusion 20, the interface between the negative electrode active material layer 12b and the first protrusion 20 is curved or bent by the step. As a result, even if a part of the negative electrode active material layer 12b becomes partially separated, the curved or bent shape of the interface changes the vector of separation of the negative electrode active material layer 12b along the interface, thereby making it possible to stop the separation of the negative electrode active material layer 12b. Particularly when the ends of the negative electrode active material layer 12b start to separate, the separation of the negative electrode active material layer 12b can be minimized, which is effective. Further, due to the curved or bent interface, it is possible to suppress the deformation of the interface region caused by the expansion of the negative electrode active material. By these effects, it is possible to suppress the separation of the negative electrode active material layer 12b from the first protrusion 20 and then the negative electrode current collector 12a. As described above, by providing the separation-stopping area 21 on the surface of the first protrusion 20 on which the negative electrode active material layer 12b is to be formed, it is possible to effectively stop the separation of the negative electrode active material layer 12b in an early stage.

Also, by providing a step with an angle θ of approximately 90°, the interface between the negative electrode active material layer 12b and the first protrusion 20 has a large bend, so that the separation of the negative electrode active material layer 12b can be stopped more effectively. Also, by providing stairs-like steps, the interface between the negative electrode active material layer 12b and the first protrusion 20 has a plurality of bends, so that the separation of the negative electrode active material layer 12b can be stopped even more effectively.

The negative electrode current collector 12a can be produced, for example, by utilizing a technique for roughening a metal foil, metal sheet, etc. Specifically, it can be produced using a roll with a regular array of depressions that will mate with the first protrusions 20 in the axial surface (hereinafter a “protrusion-forming roll”). When the first protrusions 20 are formed on one face of a plate-like metal substrate with a flat surface such as a foil, sheet, or film (hereinafter simply a “negative electrode current collector plate”), the negative electrode current collector plate is passed under pressure between a protrusion-forming roll and a roll with a flat surface such that their axes are parallel (pressing). Also, when the first protrusions 20 are formed on both faces of a negative electrode current collector plate, the negative electrode current collector plate is passed under pressure between two protrusion-forming rolls such that their axes are parallel (pressing). The pressure applied to the rolls can be selected as appropriate, depending on the material and thickness of the negative electrode current collector plate, the shape and dimensions of the first protrusions 20, the desired thickness of the negative electrode current collector 12a (i.e., the desired thickness of the negative electrode current collector plate after the pressing), etc.

The negative electrode current collector plate can be any material used as a negative electrode current collector in the technical field of lithium ion secondary batteries, and examples include foil, sheets, and films containing stainless steel, nickel, copper, or copper alloy. The thickness of the negative electrode current collector plate is not particularly limited, but it is preferably 1 to 50 μm, and more preferably 10 to 40 μm. By using such plates with such thickness, it is possible to produce the first protrusions 20 and the separation-stopping areas 21 in an industrially advantageous manner.

The protrusion-forming roll can be produced, for example, by making first holes in the predetermined positions of the surface of a ceramic roll and making second holes smaller than the first holes in the bottom of the first holes. When the first holes and the second holes are circular holes, it is preferable that the axes of the first and second holes align. The ceramic roll is composed of, for example, a core roll and a thermal spray layer, and the core roll can be made of, for example, iron or stainless steel. The thermal spray layer is formed by evenly spraying a melted or powdered ceramic material such as chromium oxide onto the surface of the core roll. The first and second holes are made in the thermal spray layer. The first and second holes are made, for example, using a laser which is commonly used to work ceramic materials and the like. The angle θ can be adjusted, for example, by adjusting the incident angle of the laser beam with respect to the thermal spray layer.

Also, a different embodiment of protrusion-forming roll can also be used. The different type of protrusion-forming roll can be composed of, for example, a core roll, a base layer, and a thermal spray layer. The core roll is the above-described roll made of, for example, iron or stainless steel. The base layer is formed on the surface of the core roll. On the surface of the base layer are formed a regular array of depressions that will mate with the first protrusions 20. These depressions can be formed in the base layer, for example, by forming a synthetic resin of high mechanical strength into a resin sheet having depressions in one face thereof, wrapping the other face of the resin sheet (i.e., the face opposite the face with the depressions) around the surface of the core roll, and bonding it. Examples of synthetic resins include thermosetting resins such as unsaturated polyester, thermo-setting polyimide, epoxy resin, and fluorocarbon resin, and thermoplastic resins such as polyamide and polyether ether ketone. The thermal spray layer is formed by spraying a melted or powdered ceramic material such as chromium oxide onto the surface of the base layer with the depressions. Thus, in consideration of the thickness of the thermal spray layer, the size of the depressions in the base layer is determined so that the depressions are larger than the designed dimension by the thickness of the thermal spray layer. In this way, a different type of protrusion-forming roll can be obtained.

Further, another embodiment of protrusion-forming roll can be produced by forming a sintered hard alloy layer including a sintered hard alloy such as tungsten carbide, instead of the ceramic layer, and making holes in the surface thereof by using a laser. The sintered hard alloy layer can be formed, for example, by fitting a cylindrical sintered hard alloy to a core roll made of the above-mentioned material by shrink fit or expansion fit. As used herein, “shrink fit” refers to a process of heating a cylindrical sintered hard alloy to expand it, fitting the expanded cylindrical alloy around a core roll, and allowing or causing the expanded cylindrical alloy to cool such that it shrinks and fits firmly around the core roll. Also, “expansion fit” as used herein refers to a process of cooling a core roll to shrink it, inserting the shrunk core roll into a cylindrical sintered hard alloy, and allowing or causing the temperature of the cold core roll to rise such that it expands and fits firmly to the cylindrical sintered hard alloy.

FIG. 4 shows schematic longitudinal sectional views of the structures of the main parts of negative electrode current collectors 25 to 27 in different embodiments.

In FIG. 4(a), the negative electrode current collector 25 has a first protrusion 30 and a separation-stopping area 31 on the surface; however, in the same manner as the first protrusions 20, a plurality of first protrusions 30 are provided so as to extend outwardly from the surface of the negative electrode current collector 25. The top face of each first protrusion 30, which is furthest from the negative electrode current collector 25, is a flat face that is substantially parallel to the surface of the negative electrode current collector 25. Also, the portion connecting the top face of the first protrusion 30 and the side face of the first protrusion 30 in the extending direction (hereinafter simply “the side face of the first protrusion 30”) is a surface with a radius of curvature (i.e., a curved surface). The separation-stopping area 31 includes a depression in the side face of the first protrusion 30 in the neighborhood of the surface of the negative electrode current collector 25. This depression extends in the circumferential direction of the side face of the first protrusion 30. Thus, in a cross-section of the first protrusion 30 perpendicular to the extending direction, the cross-sectional diameter of the first protrusion 30 is greater than the cross-sectional diameter of the separation-stopping area 31.

The negative electrode current collector 25 can be produced, for example, by a photoresist method. More specifically, the negative electrode current collector 25 having the first protrusions 30 and the separation-stopping areas 31 on the surface can be produced, for example, by forming a resist pattern on the surface of a negative electrode current collector plate by a photoresist method and applying a metal plating according to this pattern. The resist layer can be formed on the surface of the negative electrode current collector plate using a liquid resist, a dry resist film, or the like. The resist can be either of the negative type or the positive type. The thickness of the resist layer can be approximately 40 to 80%, preferably 40 to 60%, of the height of the first protrusion 30, i.e., the length from the surface of the negative electrode current collector 25 to the top face of the first protrusion 30. For example, a glass mask or resin mask with circular or polygonal dots printed thereon can be used as the mask placed on the surface of the resist layer. The dot diameter is selected from the range of, for example, approximately 1 to 20 μm. Such a mask is placed on the surface of the resist layer, and the resist layer is exposed, developed with an alkali solution, washed with water, and dried, to form a resist pattern. The negative electrode current collector plate with the resist pattern is then immersed in a plating bath to apply plating to the openings of the resist pattern. In this way, the negative electrode current collector 25 can be obtained. The metal plating is not particularly limited as long as it is a plating of a metal that does not react with lithium, and copper plating, copper alloy plating, nickel plating, chromium plating, and the like are preferred. It is also possible to employ electrolytic plating, electroless plating, or chemical plating. These photoresist and plating methods employed herein are industrial methods practically used in various industrial fields including the semiconductor field. It is thus clear that the industrial production of the negative electrode current collector 25 is easy.

As described above, by providing the separation-stopping area 31 as a depression that extends in the circumferential direction of the side face of the first protrusion 30, even if a part of the negative electrode active material layer (not shown) becomes separated from the surface of the first protrusion 30, it is possible to stop the separation and prevent the whole negative electrode active material layer from becoming separated. Even when the negative electrode active material layer is formed so as to cover the top face and the whole side face of the first protrusion 30, such a depression can reduce the separation itself of the negative electrode active material layer and can produce a sufficient separation-stopping effect. such a depression is also effective when the negative electrode active material layer is formed not only on the surface of the first protrusion 30 but also on the surface of the negative electrode current collector 25 having no first protrusion 30. For example, even if the negative electrode active material layer on the surface of the negative electrode current collector 25 becomes separated, it is possible to stop the separation and prevent the negative electrode active material layer on the surface of the first protrusion 30 from becoming separated. There is thus no need to strictly control the production conditions of the negative electrode active material layer, which is industrially advantageous.

In FIG. 4(b), the negative electrode current collector 26 has a first protrusion 32 and a separation-stopping area 33 on the surface. The first protrusion 32 is the same in structure as the first protrusions 20 and 30. The separation-stopping area 33 is a second protrusion that protrudes from the side face of the first protrusion 32 in the extending direction (hereinafter simply “the side face of the first protrusion 32”), and the second protrusion extends in the circumferential direction of the side face of the first protrusion 32. The second protrusion does not need to extend continuously in the circumferential direction of the first protrusion 32, and may extend at least partially in the circumferential direction. Also, the separation-stopping area 33 is formed on the side face of the first protrusion 32 between the vicinity of the top face of the first protrusion 32 and the vicinity of the surface of the negative electrode current collector 26. The separation-stopping area 33 may be formed on the top face of the first protrusion 32, or may be formed on both the side face and the top face. In FIG. 4(b), the second protrusion protrudes is formed in the circumferential direction of the side face of the first protrusion 32, but this is not to be construed as limiting. The second protrusion may be formed such that the tip of the second protrusion faces the same direction as the extending direction of the first protrusion 32 or the opposite direction. Also, in FIG. 4(b), only one separation-stopping area 33 is formed, but this is not to be construed as limiting, and a plurality of separation-stopping areas 33 may be formed on one or both of the top face and the side face.

The negative electrode current collector 26 can be produced, for example, by forming the first protrusions 32 on the surface of a negative electrode current collector plate and forming the separation-stopping areas 33 (second protrusions) on the side faces of the first protrusions 32. The first protrusions 32 can be formed, for example, by the pressing method using the roll employed to form the negative electrode current collector 12a or the combined method of photoresist and plating employed to form the negative electrode current collector 25. In the combined method of photoresist and plating, the thickness of the resist layer is not particularly limited, but it is preferably greater than the height of the first protrusion 32, more preferably about 1.1 to 3.5 times the height of the first protrusion 32, and most preferably about 1.5 to 3 times the height of the first protrusion 32. The dot diameter is substantially equal to the diameter of the first protrusion 32 or slightly greater. The separation-stopping areas 33 can be provided, for example, by plating. Specifically, a negative electrode current collector plate with first protrusions 32 is immersed in a plating bath, and a current equal to or greater than the limiting current value is passed therethrough for plating. As a result, a second protrusion (separation-stopping area 33) is formed so as to extend outwardly from the side face of each first protrusion 32 in the circumferential direction thereof.

When a current equal to or greater than the limiting current value is passed, metal deposits on areas where the current readily flows. In particular, the shape of the first protrusion 32 is conducive to concentration of the current, so the current readily flows through the surface of the first protrusion 32. Further, the surface of the first protrusion 32 has areas where the current flows relatively easily and areas where it does not. Metal deposits in the areas where the current readily flows, and this metal serves as a nucleus, from which the second protrusion grows. The second protrusion on the side face of the first protrusion 32 is likely to grow in the circumferential direction of the first protrusion 32. Probably for such reason, the second protrusion is almost selectively formed on the surface of the first protrusion 32.

In FIG. 4(c), the negative electrode current collector 27 has a first protrusion 34 and a separation-stopping area 35 on the surface. The first protrusion 34 is the same in structure as the first protrusions 20, 30, and 32. The separation-stopping area 35 is a depression in the side face of the first protrusion 34 in the extending direction (hereinafter simply “the side face of the first protrusion 34”), and this depression extends in the circumferential direction of the side face of the first protrusion 34. This depression (separation-stopping area 35) does not need to extend continuously in the circumferential direction of the side face of the first protrusion 34, and there may be some flat areas where the depression is not formed. The separation-stopping area 35 is formed in the side face of the first protrusion 34 between the vicinity of the top face of the first protrusion 34 and the vicinity of the surface of the negative electrode current collector 27. Also, the separation-stopping area 35 may be formed on the top face of the first protrusion 34 or may be formed on the side face and top face of the first protrusion 34. In FIG. 4(c), only one separation-stopping area 35 is formed, but this is not to be construed as limiting, and a plurality of separation-stopping areas 35 may be formed in one or both of the top face and the side face.

The negative electrode current collector 27 can be produced, for example, by forming first protrusions 34 on the surface of a negative electrode current collector plate and applying a partial etching to the predetermined area of the side face of each first protrusion 34. The etching is applied so that the cross-sectional diameter of the depression in the direction perpendicular to the protruding direction of the first protrusion 34 is smaller than the cross-sectional diameter of the first protrusion 34 itself. It is noted that when a partial etching is applied, the side face of the first protrusion 34 is often etched so that the depression does not extend continuously in the circumferential direction of the side face, but that such depression can sufficiently stop or suppress the separation of the negative electrode active material layer (not shown). It is also noted that when a partial etching is applied, not only the surface of the first protrusion 34 but also the surface of the negative electrode current collector 27 other than the first protrusion 34 may be etched. However, such depression on the surface of the negative electrode current collector 27 other than the surface of the first protrusion 34 does not adversely affect the performance of the negative electrode, causing no problems.

As in the negative electrode current collectors 26 and 27, by providing the separation-stopping area 33 or 35 in the circumferential direction of the side face of the first protrusion 32 or 34, the effect of stopping or suppressing the separation of the negative electrode active material layer (not shown) is significantly improved. Also, when the separation-stopping area includes both a depression and a second protrusion which extend in the circumferential direction of the side face of the first protrusion, a plurality of bends or curves are formed, so that the separation stopping effect is further enhanced.

The lithium ion secondary battery 1 illustrated in FIG. 1 is further described. The negative electrode active material layer 12b formed on the surface of the negative electrode current collector 12a includes a negative electrode active material. More specifically, the negative electrode active material layer 12b is formed on at least a part of the surface of the first protrusion 20, preferably on the top face of the first protrusion 20 and the side face near the top face. The negative electrode active material can be any material commonly used in this field, and examples include metal, metal fibers, carbon materials, oxides, nitrides, silicon, silicon compounds, tin, tin compounds, and various alloy materials. Among them, for example, carbon materials, silicon, silicon compounds, tin, and tin compounds are preferable in consideration of capacity density. Examples of carbon materials include various natural graphites, cokes, graphitizable carbon, carbon fibers, spherical carbon, various artificial graphites, and amorphous carbon. Examples of silicon compounds include silicon-containing alloys, silicon-containing inorganic compounds, silicon-containing organic compounds, and solid solutions thereof. Specific examples of silicon compounds include: silicon oxides represented by SiOₐ where 0.05<a<1.95; alloys containing silicon and at least one element selected from Fe, Co, Sb, Bi, Pb, Ni, Cu, Zn, Ge, In, Sn, and Ti; and solid solutions thereof. In these silicon oxides, alloys or solid solutions, a part of silicon may be replaced with at least one selected from B, Mg, Ni, Ti, Mo, Co, Ca, Cr, Cu, Fe, Mn, Nb, Ta, V, W, Zn, C, N, and Sn. Examples of tin compounds include SnO_{b} where 0<b<2, SnO₂, SnSiO₃, Ni₂Sn₄, and Mg₂Sn. These negative electrode active materials can be used singly or, if necessary, in combination of two or more of them.

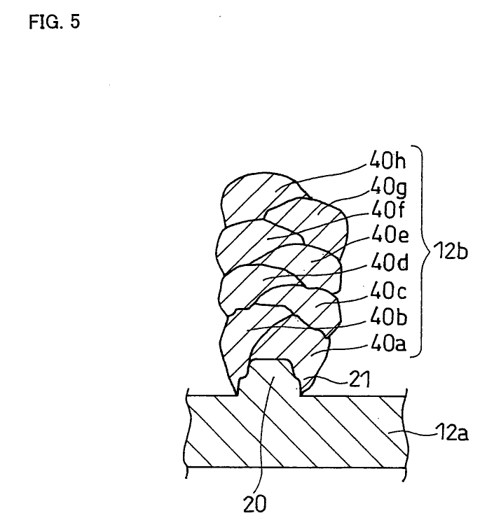

As illustrated in FIG. 2 and FIG. 5, the negative electrode active material layer 12b is preferably provided in the form of a columnar structure that extends from the surface of the first protrusion 20 in the extending direction of the first protrusion 20. The negative electrode active material layer 12b usually tends to become separated at the interface with the first protrusion 20 where the expansion strain of the negative electrode active material is maximum. However, in the present invention, the separation of the negative electrode active material layer 12b is stopped by the separation-stopping area 21 provided on the side face of the first protrusion 20. Therefore, even if a part of the negative electrode active material layer 12b becomes separated from the surface of the first protrusion 20, the partial separation does not lead to the separation of the whole negative electrode active material layer 12b.

Also, since the size of the first protrusion 20 can be made very small, the size of the negative electrode active material layer 12b can be made relatively small by appropriately adjusting the interval between the first protrusions 20. In addition, since the negative electrode active material layers 12b can be provided at an appropriate interval, the expansion/contraction stress is eased. As a result, the separation itself of the negative electrode active material layer 12b is reduced and the deformation of the negative electrode 12 is unlikely to occur.

The negative electrode active material layer 12b is more preferably provided in the form of a columnar comprising a laminate of a plurality of columnar pieces. In this embodiment, as illustrated in FIG. 5, the negative electrode active material layer 12b is provided in the form of a columnar structure consisting of a laminate of eight columnar pieces 40a, 40b, 40c, 40d, 40e, 40f, 40g, and 40h (hereinafter also collectively referred to as “columnar pieces 40”). FIG. 5 is a longitudinal sectional view of the negative electrode active material layer 12b in one embodiment. In forming the negative electrode active material layer 12b, first, the columnar piece 40a is formed so as to cover the top face of the first protrusion 20 and an adjacent part of the side face. The columnar piece 40b is then formed so as to cover the remaining part of the side face of the first protrusion 20 and a part of the top face of the columnar piece 40a. That is, in FIG. 5, the columnar piece 40a is formed on one side of the first protrusion 20 so as to include the top face, and the columnar piece 40b is formed on the other side of the first protrusion 20 while partially overlapping with the columnar piece 40a. Further, the columnar piece 40c is formed so as to cover the remaining part of the top face of the columnar piece 40a and a part of the top face of the columnar piece 40b. The columnar piece 40c is formed so that it mainly contacts the columnar piece 40a. Further, the columnar piece 40d is formed so that it mainly contacts the columnar piece 40b. Likewise, the columnar pieces 40e, 40f, 40g, and 40h are alternately laminated to form the negative electrode active material layer 12b.

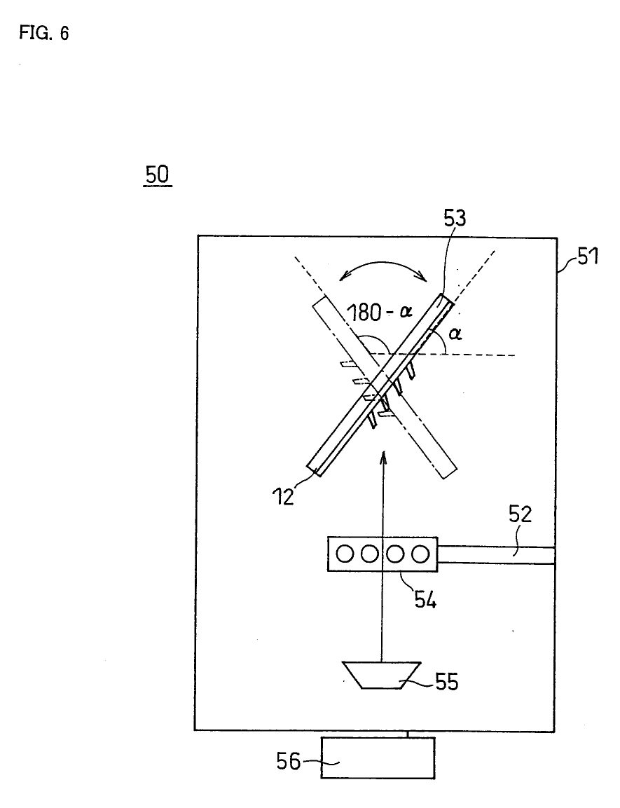

The negative electrode active material layer 12b having such a structure can be produced using, for example, an electron beam deposition device 50 illustrated in FIG. 6. FIG. 6 is a schematic side view of the structure of the electron beam deposition device 50. In FIG. 6, the respective components in the deposition device 50 are also illustrated by the solid line. The deposition device 50 includes a chamber 51, a first pipe 52, a fixing bench 53, a nozzle 54, a target 55, an electron beam generator (not shown), a power source 56, and a second pipe (not shown). The chamber 51 is a pressure-resistant container which contains the first pipe 52, the fixing bench 53, the nozzle 54, and the target 55. One end of the first pipe 52 is connected to the nozzle 54, and the other end is connected via a massflow controller (not shown) to an oxygen cylinder (not shown) placed outside the chamber 51. Oxygen is supplied to the nozzle 54 through the first pipe 52.

The fixing bench 53 is shaped like a plate and is rotatably supported, and the negative electrode current collector 12a is to be fixed to the face of the fixing bench 53 in the thickness direction thereof. The position of the fixing bench 53 is changed between the position shown by the solid line and the position shown by the dashed line in FIG. 6. When the fixing bench 53 is at the position shown by the solid line, the face to which the negative electrode current collector 12a is to be fixed faces the nozzle 54 positioned vertically below the fixing bench 53, and the angle formed between the fixing bench 53 and a straight line in the horizontal direction is α°. When the fixing bench 53 is at the position shown by the dashed line, the face to which the negative electrode current collector 12a is to be fixed faces the nozzle 54 positioned vertically below the fixing bench 53, and the angle formed between the fixing bench 53 and a straight line in the horizontal direction is (180−α)°. The angle α° can be selected as appropriate, depending on the dimensions of the desired negative electrode active material layer 12b, etc.

The nozzle 54 is disposed vertically between the fixing bench 53 and the target 55 and connected to one end of the first pipe 52. Through the nozzle 54, a mixture of vapor of a negative electrode active material or a raw material of the negative electrode active material rising vertically from target 55 and the oxygen supplied from the first pipe 52 is fed to the surface of the negative electrode current collector 12a fixed to the surface of the fixing bench 53. The negative electrode active material or the raw material of the negative electrode active material contained in the target 55 is illuminated with an electron beam by the electron beam generator, so that it is heated and becomes vapor. The power source 56, which is disposed outside the chamber 51, is electrically connected to the electron beam generator for applying a voltage necessary for electron beam generation to the electron beam generator. The second pipe is used to introduce oxygen gas into the chamber 51. An electron beam deposition device with the same structure as that of the deposition device 50 is commercially available, for example, from ULVAC, Inc.

The electron beam deposition device 50 is operated as follows. First, the negative electrode current collector 12a is fixed to the fixing bench 53, and oxygen gas is introduced into the chamber 51. In this state, a negative electrode active material or a raw material of the negative electrode active material in the target 55 is illuminated with an electron beam such that it is heated and becomes vapor. In this embodiment, silicon is used as the negative electrode active material. The vapor of the negative electrode active material or raw material thereof rises vertically, and when it passes through the nozzle 54, it is mixed with oxygen. The vapor further rises and is fed to the surface of the negative electrode current collector 12a fixed to the fixing bench 53, so that a layer containing silicon and oxygen is formed on the surface of the first protrusion (not shown). At this time, by placing the fixing bench 53 at the position shown by the solid line, the columnar piece 40a illustrated in FIG. 5 is formed on the surface of the first protrusion. Next, by displacing the fixing bench 53 to the position shown by the dashed line, the columnar piece 40b illustrated in FIG. 5 is formed. In this way, by alternately changing the position of the fixing bench 53, the negative electrode active material layer 12b which is a laminate of the eight columnar pieces 40 illustrated in FIG. 5 is formed.

A lithium metal layer may be further formed on the surface of the negative electrode active material layer 12b. The amount of lithium metal can be made equivalent to the irreversible capacity of lithium stored in the negative electrode active material layer 12b upon the initial charge/discharge. The lithium metal layer can be formed, for example, by deposition.

The separator 13 is disposed between the positive electrode 11 and the negative electrode 12. The separator 13 is a sheet or film with predetermined ion permeability, mechanical strength, insulating property, etc. Specific examples of the separator 13 include porous sheets and films such as microporous films, woven fabric, and non-woven fabric. The microporous film may be a mono-layer film or a multi-layer film (composite film). The mono-layer film is composed of one kind of material. The multi-layer film (composite film) is a laminate of mono-layer films composed of the same material or a laminate of mono-layer films composed of different materials. Various resin materials can be used as the material of the separator 13, but in consideration of durability, shut-down function, battery safety, etc., polyolefins such as polyethylene and polypropylene are preferred. The shut-down function refers to the function of a separator the through-holes of which are closed when the battery abnormally heats up, thereby suppressing the permeation of ions and shutting down the battery reaction. If necessary, the separator 13 may be composed of a laminate of two or more layers such as a microporous film, woven fabric, and non-woven fabric. The thickness of the separator 13 is typically 10 to 300 μm, but it is preferably 10 to 40 μm, more preferably 10 to 30 μm, and most preferably 10 to 25 μm. Also, the porosity of the separator 13 is preferably 30 to 70%, and more preferably 35 to 60%. The porosity as used herein refers to the ratio of the total volume of the pores in the separator 13 to the volume of the separator 13.

The separator 13 is impregnated with a lithium-ion conductive electrolyte. The lithium-ion conductive electrolyte is preferably a lithium-ion conductive non-aqueous electrolyte. Examples of non-aqueous electrolytes include liquid non-aqueous electrolytes, gelled non-aqueous electrolytes, and solid electrolytes (e.g., polymer solid electrolytes).

A liquid non-aqueous electrolyte contains a solute (supporting salt), a non-aqueous solvent, and optionally various additives. The solute is usually dissolved in the non-aqueous solvent. The liquid non-aqueous electrolyte is impregnated, for example, into the separator.

The solute can be any material commonly used in this field, and examples include LiClO₄, LiBF₄, LiPF₆, LiAlCl₄, LiSbF₆, LiSCN, LiCF₃SO₃, LiCF₃CO₂, LiAsF₆, LiBloCl₁₀, lithium lower aliphatic carboxylates, LiCl, LiBr, LiI, LiBCl₄, borates, and imide salts. Examples of borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate. Examples of imide salts include lithium bistrifluoromethanesulfonyl imide ((CF₃SO₂)₂NLi), lithium trifluoromethanesulfonyl nonafluorobutanesulfonyl imide ((CF₃SO₂)(C₄F₉SO₂)NLi), and lithium bispentafluoroethanesulfonyl imide ((C₂F₅SO₂)₂NLi). These solutes can be used singly or, if necessary, in combination of two or more of them. The amount of the solute dissolved in the non-aqueous solvent is desirably in the range of 0.5 to 2 mol/L.

The non-aqueous solvent can be any material commonly used in this field, and examples include cyclic carbonic acid esters, chain carbonic acid esters, and cyclic carboxylic acid esters. Examples of cyclic carbonic acid esters include propylene carbonate (PC) and ethylene carbonate (EC). Examples of chain carbonic acid esters include diethyl carbonate (DEC), ethyl methyl carbonate (EMC), and dimethyl carbonate (DMC). Examples of cyclic carboxylic acid esters include γ-butyrolactone (GBL) and γ-valerolactone (GVL). These non-aqueous solvents can be used singly or, if necessary, in combination of two or more of them.

Examples of additives include materials that improve coulombic efficiency and materials that deactivate a battery. For example, a material that improves coulombic efficiency decomposes on the negative electrode to form a coating film of high lithium-ion conductivity, thereby enhancing coulombic efficiency. Specific examples of such materials include vinylene carbonate (VC), 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate (VEC), and divinyl ethylene carbonate. They can be used singly or in combination of two or more of them. Among them, at least one selected from vinylene carbonate, vinyl ethylene carbonate, and divinyl ethylene carbonate is preferable. A part of the hydrogen atoms contained in these compounds may be replaced with fluorine atom(s).

For example, a material that deactivates a battery decomposes upon battery overcharge to form a coating film on the electrode surface, thereby deactivating the battery. Examples of such materials include benzene derivatives. Examples of benzene derivatives include benzene compounds containing a phenyl group and a cyclic compound group adjacent to the phenyl group. Preferable examples of cyclic compound groups include phenyl groups, cyclic ether groups, cyclic ester groups, cycloalkyl groups, and phenoxy groups. Specific examples of benzene derivatives include cyclohexyl benzene, biphenyl, and diphenyl ether. These benzene derivatives can be used singly or, if necessary, in combination of two or more of them. However, the content of the benzene derivative in the liquid non-aqueous electrolyte is preferably equal to or less than 10 parts by volume per 100 parts by volume of the non-aqueous solvent.

A gelled non-aqueous electrolyte includes a liquid non-aqueous electrolyte and a polymer material. The polymer material retains the liquid non-aqueous electrolyte by gelling it. The polymer material can be any material commonly used in this field, and examples include polyvinylidene fluoride, polyacrylonitrile, polyethylene oxide, polyvinyl chloride, and polyacrylate.

A solid electrolyte includes, for example, a solute (supporting salt) and a polymer material. The solute can be the same material as that described above. Examples of polymer materials include polyethylene oxide (PEO), polypropylene oxide (PPO), and a copolymer of ethylene oxide and propylene oxide.

One end of the positive electrode lead 14 is connected to the positive electrode current collector 11a, and the other end is drawn to the outside of the lithium ion secondary battery 1 through an opening 17a of the exterior case 17. One end of the negative electrode lead 15 is connected to the negative electrode current collector 12a, and the other end is drawn to the outside of the lithium ion secondary battery 1 through an opening 17b of the exterior case 17. The positive electrode lead 14 and the negative electrode lead 15 can be any material commonly used in the technical field of lithium ion secondary batteries. Also, the openings 17a and 17b of the exterior case 17 are sealed with the gasket 16. For the gasket 16, for example, various resin materials can be used. The exterior case 17 can also be any material commonly used in the technical field of lithium ion secondary batteries. The openings 17a and 17b of the exterior case 17 can be directly sealed by welding or the like, without using the gasket 16.

The lithium ion secondary battery 1 can be produced, for example, as follows. First, one end of the positive electrode lead 14 is connected to the face of the positive electrode current collector 11a opposite the face on which the positive electrode active material layer 11b is formed. Likewise, one end of the negative electrode lead 15 is connected to the face of the negative electrode current collector 12a opposite the face on which the negative electrode active material layer 12b is formed. Next, the positive electrode 11 and the negative electrode 12 are laminated with the separator 13 interposed therebetween, to form an electrode group. At this time, the positive electrode 11 and the negative electrode 12 are disposed so that the positive electrode active material layer 11a and the negative electrode active material layer 12a face each other. This electrode group is inserted, with the electrolyte, into the exterior case 17, and the other end of the positive electrode lead 14 and the other end of the negative electrode lead 15 are drawn to the outside of the exterior case 17. In this state, while the exterior case 17 is being evacuated, the openings 17a and 17b are welded with or without the gasket 16, to produce the lithium ion secondary battery 1.

The lithium ion secondary battery 1 of the invention can be used in the same applications as conventional lithium ion secondary batteries, and in particular, can be used preferably as the power source for portable electronic devices such as personal computers, cellular phones, mobile devices, portable digital assistants, and portable game machines.

The invention is hereinafter described specifically by way of Examples and Comparative Examples.

### EXAMPLE 1

A lithium ion secondary battery with the same structure as the lithium ion secondary battery 1 of FIG. 1 was produced in the following manner.

### (1) Preparation of Positive Electrode

A positive electrode mixture paste was prepared by sufficiently mixing 10 g of lithium cobaltate (LiCoO₂, positive electrode active material) powder with a mean particle size of approximately 10 μm, 0.3 g of acetylene black (conductive agent), 0.8 g of polyvinylidene fluoride powder (binder), and 5 ml of N-methyl-2-pyrrolidone (NMP). This positive electrode mixture paste was applied onto one face of a 20-μm thick aluminum foil (positive electrode current collector), dried, and rolled to form a positive electrode active material layer. This was then cut into a square of 30 mm×30 mm, to obtain a positive electrode. In the positive electrode thus obtained, the positive electrode active material layer carried on one face of the aluminum foil had a thickness of 70 μm and a size of 30 mm×30 mm. A positive electrode lead was connected to the face of the aluminum foil opposite the face on which the positive electrode active material layer was formed.

### (2) Preparation of Negative Electrode

Melted chromium oxide was sprayed on the surface of a 50-mm diameter iron roll to form a 100-μm thick ceramic layer. Using a laser, circular holes (depressions) with a diameter of 12 μm and a depth of 3 μm were made in the surface of this ceramic layer. These holes (hereinafter “first holes”) were arranged in the close-packed arrangement at an axis-to-axis distance of 20 μm. The bottom of each first hole was substantially flat in the central part thereof, and the corners formed by the ends of the bottom and the side faces of the first hole were rounded. The length from the surface of the ceramic layer to the center of the bottom of the first hole was 3 μm. The center of the bottom was deeper than the ends of the bottom, and the difference in depth between the center of the bottom and the ends of the bottom was 1 μm or less. Next, circular holes (depressions) with a diameter of 8 μm and a depth of 5 μm were formed in the bottom of the first holes so that the axes of these holes (hereinafter “second holes”) were aligned with the axes of the first holes. The second holes had the same shape as the first holes, with the bottom being semiround and the length (depth) from the surface of the ceramic layer to the center of the bottom of the second hole being 8 μm. In this way, two protrusion-forming rolls were prepared.

Meanwhile, a copper alloy foil containing 0.03% by weight of zirconia relative to the whole amount (trade name: HCL-02Z, thickness 20 μm, available from Hitachi Cable Ltd.) was heated at 600% in an argon gas atmosphere for 30 minutes for annealing. This copper alloy foil was passed under pressure between the two protrusion-forming rolls at a linear load of 2 t/cm, so that both faces of the copper alloy foil were pressed. In this way, the negative electrode current collector used in the invention was prepared. A section of the negative electrode current collector in the thickness direction thereof was observed with a scanning electron microscope, and the negative electrode current collector was found to have protrusions (first protrusions) on the surface. Each of these protrusions was composed of a 12-μm diameter step on the surface of the negative electrode current collector (hereinafter “first step”) and a 8-μm diameter step on top of the surface of the first step (hereinafter “second step”). The difference in level on the side face between the first step and the second step was 2 μm, and the height of the protrusion was 8 μm. The protrusions had the same shape as the first protrusion 20 shown in FIG. 3. This negative electrode current collector was cut into a size of 40 mm×40 mm, and a negative electrode active material layer was formed thereon in the following manner.

A negative electrode active material layer was formed on the protrusions on the surface of the negative electrode current collector, using a commercially available deposition device (available from ULVAC, Inc.) with the same structure as the electron beam deposition device 50 of FIG. 6. The deposition conditions were as follows. The position of the fixing bench to which the 40 mm×40 mm negative electrode current collector was fixed was alternately changed between the position at which the angle α=60° (the position shown by the solid line in FIG. 6) and the position at which (180−α)=120° (the position shown by the dashed line in FIG. 6). The angle α is the angle formed by the fixing bench and a straight line in the horizontal direction. The negative electrode active material layer thus formed had a columnar structure composed of a laminate of eight columnar pieces as illustrated in FIG. 5. The negative electrode active material layer was grown from the top face of the protrusion and the side face near the top face in the extending direction of the protrusion.

Raw material of negative electrode active material (evaporation source): silicon, purity 99.9999%, available from Kojundo Chemical Laboratory Co., Ltd

Oxygen ejected from nozzle: purity 99.7%, available from Taiyo Nippon Sanso Corporation

Flow rate of oxygen ejected from nozzle: 80 sccm

Angle α: 60°

Acceleration voltage of electron beam: −8 kV

Emission: 500 mA

Deposition time: 3 minutes

The thickness T of the negative electrode active material layer thus formed was 16 μm. The thickness of the negative electrode active material layer can be obtained by observing a cross-section of the negative electrode in the thickness direction thereof with a scanning electron microscope, selecting 10 negative electrode active material layers formed on the surfaces of the protrusions, measuring the length from the vertex of the protrusion to the vertex of the negative electrode active material layer, and averaging the 10 measured values. Also, the amount of oxygen contained in the negative electrode active material layer was quantified by a combustion method, and the result showed that the composition of the compound constituting the negative electrode active material layer was SiO_{0.5}. Also, the porosity P of the negative electrode active material layer was 50%. The porosity P was calculated from the following formula:

Porosity P=(volume of negative electrode active material layer−theoretical volume of negative electrode active material layer)/(volume of negative electrode active material layer)×100

In the above formula, volume of negative electrode active material layer=thickness T of negative electrode active material layer (16 μm)×area S of negative electrode active material layer (31 mm×31 mm=961 mm²), and theoretical volume of negative electrode active material layer=weight W of negative electrode active material layer/density D of negative electrode active material layer.

The theoretical volume of the negative electrode active material layer is the volume of the negative electrode active material layer that is assumed to have no pores. Also, the weight W of the negative electrode active material layer was determined by subtracting the weight of the negative electrode current collector from the weight of the negative electrode. Also, the weight of the negative electrode, the weight of the negative electrode current collector, and the area of the negative electrode active material layer were the values of the negative electrode that was cut into a size of 31 mm×31 mm in a subsequent step.

Next, lithium metal was deposited on the negative electrode active material layer. By depositing the lithium metal, the negative electrode active material layer was supplemented with lithium corresponding to the irreversible capacity in the initial charge/discharge. The deposition of lithium metal was performed under an argon atmosphere, using a resistance heating deposition device (available from ULVAC, Inc.). A tantalum boat in the resistance heating deposition device was charged with lithium metal, and the negative electrode was fixed so that the negative electrode active material layer faced the tantalum boat. While the tantalum boat was supplied with a current of 50 A, deposition was performed in an argon atmosphere for 10 minutes.

### (3) Production of Battery

An electrode group was assembled by laminating the positive electrode, a polyethylene microporous film (separator, trade name: Hipore, thickness 20 μm, available from Asahi Kasei Corporation), and the negative electrode, so that the positive electrode active material layer and the negative electrode active material layer faced each other with the polyethylene microporous film interposed therebetween. This electrode group was inserted, with an electrolyte, into an exterior case made of an aluminum laminate sheet. The electrolyte used was a non-aqueous electrolyte prepared by dissolving LiPF₆ at a concentration of 1.0 mol/L in a solvent mixture of ethylene carbonate (EC) and ethyl methyl carbonate (EMC) in a volume ratio of 1:1. Next, the positive electrode lead and a negative electrode lead were drawn to the outside of the exterior case through the openings of the exterior case. While the exterior case was being evacuated, the openings of the exterior case were welded. In this way, a lithium ion secondary battery of the invention was produced.

### COMPARATIVE EXAMPLE 1

This comparative example is the same as Example 1 except that protrusion-forming rolls were prepared as follows. First, a ceramic layer of chromium oxide was formed on the surface of an iron roll in the same manner as in Example 1. Using a laser, circular holes (depressions) with a diameter of 12 μm and a depth of 11 μm were made in the surface of the ceramic layer. The holes were arranged in the close-packed arrangement at an axis-to-axis distance of adjacent holes of 20 μm. Also, the bottom of each hole had the same shape as the bottom of the first hole in Example 1, and the length from the surface of the ceramic layer to the center of the bottom of the hole was 11 μm. In this way, two protrusion-forming rolls were prepared. A copper alloy foil, which was annealed in the same manner as in Example 1, was passed under pressure between the two protrusion-forming rolls at a linear load of 2 t/cm, so that both faces of the copper alloy foil were pressed. In this way, a negative electrode current collector of this comparative example was prepared. The negative electrode current collector had 12-jm diameter protrusions on the surface. A cross-section of the negative electrode current collector in the thickness direction thereof was observed with a scanning electron microscope, and the height of the protrusions was 8 μm. Also, the side faces of the protrusions had no separation-stopping area. Using this negative electrode current collector, a lithium ion secondary battery for comparison was produced in the same manner as in Example 1.

The features of the negative electrode current collectors prepared in Example 1 and Comparative Example 1 are summarized in Table 1. Also, the lithium ion secondary batteries prepared in Example 1 and Comparative Example 1 were evaluated for their charge/discharge cycle characteristic in the following manner. The results are also shown in Table 1.

### [Charge/Discharge Cycle Characteristic]

The lithium ion secondary batteries of Example 1 and Comparative Example 1 were placed in a 20° C. constant temperature oven and subjected to 100 charge/discharge cycles of a constant current charge, a constant voltage charge, a 20-minute interval, and a discharge. The percentage of the total discharge capacity at the 100^{th} cycle relative to the total discharge capacity at the 1^{st} cycle was obtained as the cycle capacity retention rate.

Constant current charge: the batteries were charged at a constant current of 1 C rate (1 C is the current value at which the whole battery capacity can be used in 1 hour) until the battery voltage reached 4.2 V.

Constant voltage charge: the batteries were charged at the constant voltage until the current value reached 0.05 C.

Discharge: the batteries were discharged until the battery voltage dropped to 2.5 V.

Also, after the 100 cycles, the negative electrodes were visually inspected for separation and wrinkles. Separation refers to separation of the negative electrode active material layer from the negative electrode current collector. Wrinkles refer to wrinkles in the negative electrode surface, and the occurrence of wrinkles means deformation of the negative electrode. The evaluation results are shown in “State of electrode plate after cycles” in Table 1.

It is noted that these lithium ion secondary batteries are designed such that the battery capacity is determined by the capacity of the positive electrode, since lithium was deposited on the negative electrode to compensate for the irreversible capacity. That is, when the battery voltage is 2.5 V (cut-off voltage of discharge), the positive electrode potential is 3 V and the negative electrode potential is 0.5 V versus lithium, and upon a drop in positive electrode potential, the discharge finishes.

TABLE 1

| | Separation-stopping area | | | | | |
|---|---|---|---|---|---|---|
| | | Size | | | Cycle | State of |
| Lithium ion | | | Diameter | Diameter | capacity | electrode |
| secondary | | Difference | of first | of second | retention | plate after |
| battery | Step | in level | step | step | rate | cycles |
| Example 1 | Step | 2 μm | 12 μm | 8 μm | 83% | Neither |
| | | | | | | separated |
| | | | | | | nor |
| | | | | | | wrinkled |

| | | | | |
|---|---|---|---|---|
| Comparative | None | Protrusion diameter 12 μm | 60% | Separated |
| Example 1 | | | | and |
| | | | | wrinkled |

In the battery of Example 1, since the separation-stopping area (the step provided on each of the protrusions on the surface of the negative electrode current collector) suppresses the separation of the columnar negative electrode active material layer on the surface of the protrusion, the separation of the negative electrode active material layer was minimized. Also, since the protrusions were provided at an appropriate interval, spaces were created around the columnar negative electrode active material layers on the surfaces of the protrusions, and the spaces served to ease the stress created by the expansion and contraction of the negative electrode active material. Probably for these reasons, the cycle capacity retention rate and the charge/discharge cycle characteristic were significantly improved and the deformation of the negative electrode could be suppressed. Preferably, the spaces around the negative electrode active material layers are equivalent to or slightly grater than the volume of expansion of the negative electrode active material layer. By this, it is possible to relieve the stress that occurs particularly upon expansion of the negative electrode active material. It should be noted, however, that even when these spaces are equivalent to or slightly grater than the volume of expansion of the negative electrode active material layer, if the spaces are unevenly present or enclosed by the negative electrode active material layers, it is not possible to relieve the stress upon the expansion of the negative electrode active material and suppress the deformation of the negative electrode.

On the other hand, in the battery of Comparative Example 1, since the side face of the protrusion has no separation-stopping area, the negative electrode active material layer becomes distorted due to expansion of the negative electrode active material. As a result, a stress is created between the negative electrode active material layer and the protrusion, and this stress is believed to cause separation of the negative electrode active material layer and then the separation at almost the whole area of the interface between the negative electrode active material layer and the protrusion. Probably for this reason, when the charge/discharge cycle was repeated, the cycle capacity retention rate sharply dropped, the charge/discharge cycle characteristic lowered, and the deformation of the negative electrode occurred.

### EXAMPLE 2

This example is the same as Example 1 except that protrusion-forming rolls were produced as follows. First, a ceramic layer of chromium oxide was formed on the surface of an iron roll in the same manner as in Example 1. Using a laser, circular first holes (depressions) with a diameter of 12 μm and a depth of 3 μm were made in the surface of the ceramic layer. The first holes were arranged in the close-packed arrangement at an axis-to-axis distance of adjacent holes of 20 μm. Also, the bottom of each first hole had the same shape as the bottom of the first hole in Example 1, and the length from the surface of the ceramic layer to the center of the bottom of the first hole was 3 μm. Next, circular second holes (depressions) with a diameter of 8 μm and a depth of 3 μm were made in the bottom of the first holes so that their axes were aligned with the axes of the first holes. The second holes also had the same shape as the first holes, and the length from the surface of the ceramic layer to the center of the bottom of the second hole was 6 μm. Further, circular third holes (depressions) with a diameter of 4 μm and a depth of 3 μm were made in the bottom of the second holes so that their axes were aligned with the axes of the first holes. The third holes also had the same shape as the first holes, and the length from the surface of the ceramic layer to the center of the bottom of the third hole was 9 μm. In this way, two protrusion-forming rolls were prepared. A copper alloy foil, which was annealed in the same manner as in Example 1, was passed under pressure between the two protrusion-forming rolls at a linear load of 2 t/cm, so that both faces of the copper alloy foil were pressed. In this way, a negative electrode current collector of the invention was prepared.

A cross-section of the negative electrode current collector in the thickness direction thereof was observed with a scanning electron microscope, and the negative electrode current collector was found to have protrusions (first protrusions) on the surface. Each of the protrusions was composed of a 12-μm diameter first step on the surface of the negative electrode current collector, a 8-μm diameter second step on the surface of the first step, and a 3-μm diameter third step on the surface of the second step. On the side face, the difference in level between the first and second steps and the difference in level between the second and third steps were 3 μm, and the height of the protrusion was 8 μm. Using this negative electrode current collector, a lithium ion secondary battery of the invention was produced in the same manner as in Example 1.

### EXAMPLE 3

A lithium ion secondary battery of the invention was produced in the same manner as in Example 1 except that a negative electrode current collector was produced as follows.

A 6-μm thick dry film resist (trade name: PHOTEC RY-3300, available from Hitachi Chemical Company, Ltd.) was attached to the surface of a copper alloy foil (trade name HCL-02Z, available from Hitachi Cable Ltd.). Also, 8-μm diameter circular dots were printed on a resin mask. The circular dots were arranged in the close-packed arrangement at a center-to-center distance of 20 μm. This resin mask was placed on the dry film resist, irradiated with i rays using a collimated light aligner, and developed with a 1 wt % sodium carbonate aqueous solution to form a resist pattern. Next, copper protrusions were formed in the openings of the resist by a plating method. The copper alloy foil with the resist pattern was immersed as the cathode in a copper sulfate aqueous solution containing 270 g/liter of copper (II) sulfate pentahydrate and 100 g/liter of sulfuric acid. At a current density of 5 A/dm² and a liquid temperature of 50%, a copper plating of 8 μm in thickness was formed. As a result, a regular array of copper protrusions (first protrusions) were formed on the surface of the copper alloy foil. In this way, a negative electrode current collector was prepared. These protrusions had the same shape as the first protrusion 25 illustrated in FIG. 4(a), and a depression (separation-stopping area) was formed in the side face of each protrusion near the surface of the copper alloy foil, and the depression extended in the circumferential direction. A cross-section of this negative electrode current collector in the thickness direction was observed with a scanning electron microscope. The result showed that the cross-sectional diameter in the direction perpendicular to the extending direction of the protrusion was 8 μm in the region of the side face of the protrusion corresponding to the resist thickness and 12 μm at maximum above the region corresponding to the resist thickness. Using this negative electrode current collector, a lithium ion secondary battery of the invention was produced in the same manner as in Example 1.

### EXAMPLE 4

In the same manner as in Comparative Example 1, a copper alloy foil with circular protrusions (first protrusions) of 12 μm in diameter and 8 μm in height on the surface was prepared. These circular protrusions were arranged in the close-packed arrangement at an axis-to-axis distance of 20 μm on the surface of the copper alloy foil. This copper alloy foil was immersed in a copper sulfate aqueous solution containing 47 g/liter of copper (II) sulfate pentahydrate and 100 g/liter of sulfuric acid, and was plated at a current density of 30 A/dm² and a liquid temperature of 50%. As a result, second protrusions (separation-stopping areas) were formed in the side faces of the circular protrusions in the circumferential direction. Further, this copper alloy foil was immersed in a copper sulfate aqueous solution containing 235 g/liter of copper (II) sulfate pentahydrate and 100 g/liter of sulfuric acid, and was plated at a current density of 3 A/dm² and a liquid temperature of 50° C. to improve the adhesion between the circular protrusions and the second protrusions. The average length of the second protrusions from the circular protrusion surface to the second protrusion tip (height of second protrusion) was 2 μm. The second protrusion formed on the side face of each circular protrusion extended continuously in the circumferential direction. Further, the second protrusion was also formed on the top face of the circular protrusion. Using this negative electrode current collector, a lithium ion secondary battery of the invention was produced in the same manner as in Example 1.

### EXAMPLE 5

In the same manner as in Comparative Example 1, a copper alloy foil with circular protrusions (first protrusions) of 12 μm in diameter and 8 μm in height on the surface was prepared. These circular protrusions were arranged in the close-packed arrangement at an axis-to-axis distance of 20 μm These circular protrusions were partially etched using an etchant (trade name: MEC etch BOND CZ-8100, MEC COMPANY LTD.) at an etchant temperature of 35° C. for an etching time of 30 seconds. These etching temperature and etching time are the conditions under which the surface roughness Ra of the flat surface of a copper alloy foil becomes 1 μm after etching. As the result of the partial etching, a 1-μm deep groove (depression) was formed in the side face of each protrusion so as to extend in the circumferential direction. Further, a similar groove was also formed on the top face of the protrusion. Using this negative electrode current collector, a lithium ion secondary battery of the invention was produced in the same manner as in Example 1.

The features of the separation-stopping areas prepared in Examples 2 to 5 are summarized in Table 2. Also, the lithium ion secondary batteries prepared in Examples 2 to 5 were evaluated for their charge/discharge cycle characteristic (cycle capacity retention rate) in the same manner as in Example 1. The results are also shown in Table 2.

TABLE 2

| | Separation-stopping area | | | | | |
|---|---|---|---|---|---|---|
| Lithium | | Size | | | | Cycle |
| ion | | | Diameter | Diameter | Diameter | capacity |
| secondary | | Difference | of first | of second | of third | retention |
| battery | Shape | in level | step | step | step | rate |
| Example 2 | Stairs-like | 2 μm | 12 μm | 8 μm | 3 μm | 87% |
| | steps | | | | | |

| | | | |
|---|---|---|---|
| Example 3 | Depression | Depth from protrusion surface: | 82% |
| | | equal to or less than 2 μm | |
| Example 4 | Second | Average height of second protrusion: 2 μm | 90% |
| | protrusion | | |
| Example 5 | Depression | Depth from protrusion surface: 1 μm | 88% |

Table 2 clearly shows that the lithium ion secondary batteries of Examples 2 to 5 have an excellent charge/discharge cycle characteristic. After the charge/discharge cycles, electrode plates of these lithium ion secondary batteries were free from the separation of the negative electrode active material layer and the deformation of the negative electrode.

In the battery of Example 2, the stairs-like steps are believed to enhance the separation stopping effect. As in the battery of Example 3, the depression in the side face of the protrusion near the surface of the negative electrode current collector is also believed to produce a separation stopping effect in the same manner as the stairs-like steps.

The battery of Example 4 had the best charge/discharge cycle characteristic. This is probably because the provision of the second protrusion (separation-stopping area) on the top face as well as on the side face of the protrusion produced a very high separation stopping effect at the whole area of the interface between the protrusion and the negative electrode active material layer. Further, the second protrusion increased the total surface area of the protrusion, thereby producing an anchor effect on the negative electrode active material layer, and this anchor effect is also believed to be a cause of the increased adhesion between the protrusion and the negative electrode active material layer.

The battery of Example 5 also had an excellent cycle characteristic as the battery of Example 4. This is probably because the groove (separation-stopping area) was formed not only in the side face of the protrusion but also in the top face as the battery of Example 4.

The above results demonstrate that the effective shapes as the separation-stopping area are a step (including stairs-like-steps), a second protrusion, and a depression formed in the side face and/or the top face of the protrusion. These results also indicate that a combination of two or more effective shapes can further enhance the separation stopping effect.

### EXAMPLES 6 TO 8

Lithium ion secondary batteries of the invention were produced in the same manner as in Example 1, except that the diameter and depth of the second holes of the protrusion-forming rolls were changed to 11 μm and 5 μm, respectively (Example 6), 10 μm and 5 μm (Example 7), or 6 μm and 5 μm (Example 8).

In Example 6, protrusions (first protrusions) having a 0.5 μm difference in level on the side face were formed. In Example 7, protrusions (first protrusions) having a 1 μm difference in level on the side face were formed. In Example 8, protrusions (first protrusions) having a 3 μm difference in level on the side face were formed.

### EXAMPLE 9

A lithium ion secondary battery of the invention was produced in the same manner as in Example 1, except that the diameter of the first holes of the protrusion-forming rolls was changed to 16 μm, and that the diameter and depth of the second holes of the protrusion-forming rolls were changed to 6 μm and 5 μm, respectively. In Example 9, protrusions (first protrusions) having a 5 μm difference in level on the side face were formed.

The features of the separation-stopping areas prepared in Examples 6 to 9 are summarized in Table 3. Also, the lithium ion secondary batteries produced in Examples 6 to 9 were evaluated for their charge/discharge cycle characteristic (cycle capacity retention rate) and their negative electrode state after the charge/discharge cycles in the same manner as in Example 1. The results are also shown in Table 3.

TABLE 3

| | Separation-stopping area | | | | | |
|---|---|---|---|---|---|---|
| | | Size | | | Cycle | State of |
| Lithium ion | | | Diameter | Diameter | capacity | electrode |
| secondary | | Difference | of first | of second | retention | plate after |
| battery | Shape | in level | step | step | rate | cycles |
| Example 6 | Step | 0.5 μm | 12 μm | 11 μm | 75% | *10% separation |
| Example 7 | Step | 1 μm | 12 μm | 10 μm | 83% | Not separated |
| Example 8 | Step | 3 μm | 12 μm | 6 μm | 84% | Not separated |
| Example 9 | Step | 5 μm | 16 μm | 6 μm | 75% | *10% separation |

*10% separation: 10% of the active material layers formed on the protrusions became separated from the current collector.

A comparison between the evaluation result of the battery of Example 6 and the evaluation result of the battery of Comparative Example 1 indicates that even a 0.5 μm difference in level can produce a separation stopping effect. Also, the evaluation results of the batteries of Examples 7 and 8 demonstrate that a 1 μm or more difference in level is more effective. These results show that the difference in level is preferably 0.5 μm or more, and more preferably 1 μm or more, in order to stop the separation. Also, the evaluation result of Example 9 indicates that when the difference in level is 5 μm, the spaces created around the negative electrode active material layers by the shadow effect of the protrusions are insufficient, and that the electrode plate may become wrinkled upon the expansion of the negative electrode active material. Therefore, the difference in level is preferably 0.5 μm to 3 μm. In Examples 6 to 9, the difference in level was varied, but when the separation-stopping area has other shapes which stop the separation on the same principle, the dimension thereof is also preferably 0.5 μm to 3 μm.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A negative electrode for a lithium ion secondary battery, comprising:
a negative electrode current collector made of metal and shaped like a plate;
first protrusions extending outwardly from a surface of said negative electrode current collector;
a columnar structure formed on at least a top face of each of said first protrusions, said columnar structure including a negative electrode active material; and
a separation-stopping area provided on at least a part of a surface of each of said first protrusions for stopping said columnar structure from becoming separated from the surface of said first protrusion due to expansion or contraction of said negative electrode active material.

2. The negative electrode for a lithium ion secondary battery in accordance with claim 1, wherein said separation-stopping area is provided on at least a part of a side face of each of said first protrusions.

3. The negative electrode for a lithium ion secondary battery in accordance with claim 2, wherein said separation-stopping area includes one or more steps formed on the side face of each of said first protrusions.

4. The negative electrode for a lithium ion secondary battery in accordance with claim 3, wherein at least one of said one or more steps is shaped like stairs.

5. The negative electrode for a lithium ion secondary battery in accordance with claim 2, wherein said separation-stopping area includes one or both of:
1) a depression in said side face of said first protrusion; and
2) a second protrusion extending outwardly from said side face of said first protrusion,
in the circumferential direction of the side face of said first protrusion.

6. The negative electrode for a lithium ion secondary battery in accordance with claim 5, wherein said depression is formed in the side face of said first protrusion near the surface of said negative electrode current collector.

7. A lithium ion secondary battery comprising:
a positive electrode including a positive electrode active material capable of reversibly absorbing and desorbing lithium ions;
the negative electrode for a lithium ion secondary battery in accordance with claim 1;
a separator; and
a lithium-ion conductive electrolyte.
